(19) United States
(12) Patent Application Publication
(10) Pub. No.: US 2024/0117909 A1
(43) Pub. Date: Apr. 11, 2024

(54) BEARING CAMLOCK

(71) Applicant: Schaeffler Technologies AG & Co. KG, Herzogenaurach (DE)

(72) Inventor: Elias Ferreira Machado, Sorocaba (BR)

(73) Assignee: Schaeffler Technologies AG & Co. KG, Herzogenaurach (DE)

(21) Appl. No.: 17/962,663

(22) Filed: Oct. 10, 2022

(51) Int. Cl. F16L 37/18

(52) U.S. Cl. CPC F16L 37/18

(57) ABSTRACT

An assembly includes: a housing, a shaft, a bearing, and a camlock. The shaft is arranged concentrically with the housing and is rotatable relative to the housing. The bearing supports the shaft in the housing. The camlock is configured to axially constrain the bearing relative to the shaft. The camlock includes a body arranged on the shaft and two arms pivotally connected to the body. The arms are selectively engageable with the shaft to fix the body relative to the shaft.

### TECHNICAL FIELD

The present disclosure relates generally to a camlock, and more specifically to a camlock configured to fix a bearing relative to a shaft and an assembly including the camlock.

### BACKGROUND

An assembly may include a housing and a shaft rotatable relative to the housing. The assembly may further include a bearing rotatably supporting the shaft within the housing. In some arrangements, the bearing may be axially constrained relative to the shaft, e.g., via a nut threadedly engaged with the shaft. During operation, the bearing may require maintenance/replacement due to contamination, e.g., debris, water, etc., entering the bearing. Axially constraining the bearing via a nut threadedly engaged with the shaft increases an amount of time to access the bearing for maintenance/replacement. Therefore, it is desirable to have alternative designs and configurations that can axially constrain the bearing to the shaft while reducing the amount of time to access the bearing for maintenance/replacement.

### SUMMARY

Embodiments disclosed herein provide an assembly including: a housing, a shaft, a bearing, and a camlock. The shaft is arranged concentrically with the housing and is rotatable relative to the housing. The bearing supports the shaft in the housing. The camlock is configured to axially constrain the bearing relative to the shaft. The camlock includes a body arranged on the shaft and two arms pivotally connected to the body. The arms are selectively engageable with the shaft to fix the body relative to the shaft.

In embodiments, the shaft may include a shoulder disposed external to the housing. The bearing may be disposed between the shoulder and the camlock. The camlock may be axially spaced from the bearing and a spring may be disposed between the camlock and the bearing. The spring may be configured to engage the camlock and the bearing and to axially bias the bearing towards the shoulder.

In embodiments, the bearing may include an inner ring and an outer ring arranged concentrically with the inner ring. The body of the camlock may be integral with the inner ring. In embodiments, the body of the camlock may be radially aligned with the inner ring.

In embodiments, the body may be spaced from the bearing and a spring may be disposed between the body and the bearing. The spring may be configured to engage the body and the bearing and to axially bias the bearing away from the camlock.

In embodiments, the shaft may include a groove extending circumferentially about the shaft. Each arm may include a cam configured to engage the shaft in the groove. In embodiments, the body may include two slots arranged diametrically opposite of each other. Each arm may be disposed in one respective slot.

In embodiments, each arm may include a first end having a cam configured to engage the shaft and a second end spaced from the first end. The second ends of the arms may be selectively connectable to each other. In a locked position, the second ends may be connected to each other. The camlock may include a wire selectively engageable with the second ends of the arms when the camlock is in the locked position.

Embodiments disclosed herein further provide a camlock including a body configured to be arranged on a shaft and two arms pivotally connected to the body. The arms are configured to selectively engage the shaft to fix the body relative to the shaft.

In embodiments, each arm may include a cam configured to engage the shaft. In embodiments, the body may include two slots arranged diametrically opposite of each other. Each arm may be disposed in one respective slot.

In embodiments, each arm may include a first end having a cam configured to engage the shaft and a second end spaced from the first end. The second ends of the arms may be selectively connectable to each other. In a locked position, the second ends may be connected to each other. The camlock may include a wire selectively engageable with the second ends of the arms when the camlock is in the locked position.

Embodiments disclosed herein further provide an assembly including a bearing and a camlock configured to axially constrain the bearing relative to a shaft. The camlock includes a body configured to be arranged on the shaft and two arms pivotally connected to the body. The arms are configured to selectively engage the shaft to fix the body relative to the shaft.

In embodiments, the bearing may include an inner ring and an outer ring arranged concentrically with the inner ring. The body of the camlock may be integral with the inner ring.

### BRIEF DESCRIPTION OF THE DRAWINGS

FIG. 1 illustrates an exploded view of an assembly including a camlock according to an example embodiment of the present disclosure.

FIG. 2 illustrates a cross-sectional view of the assembly with the camlock in an unlocked position.

FIG. 3 illustrates a cross-sectional view of the assembly with the camlock in a locked position.

FIG. 4 illustrates an exploded view of the camlock according to the example embodiment of the present disclosure.

FIG. 5 illustrates a cross-sectional view of the assembly with a camlock according to another example embodiment of the present disclosure.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

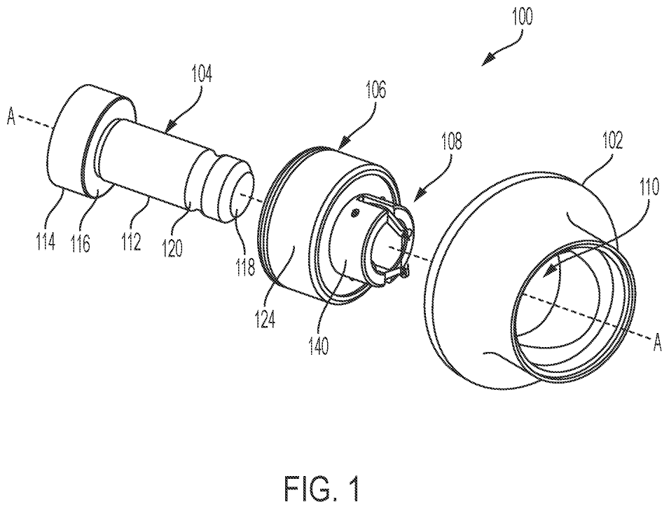

Referring to FIGS. 1-3, an assembly 100 is illustrated according to one embodiment of the present disclosure. The assembly 100 includes: a housing 102, a shaft 104, a bearing 106, and a camlock 108. The housing 102 defines a cavity 110 extending annularly about a central axis A. Words such as “axial,” “radial,” “circumferential,” “outward,” etc. as used herein are intended to be with respect to the central axis A. The housing 102 and the shaft 104 are arranged concentrically with each other. The shaft 104 is rotatable relative to the housing 102 about the central axis A.

The shaft 104 includes a first portion 112 disposed in the cavity 110 and a second portion 114 disposed external to the cavity 110. The shaft 104 further includes a shoulder 116 extending radially outward from the first portion 112 to the second portion 114. The first portion 112 includes an end 118 axially spaced from the shoulder 116. The first portion 112 extends axially from the shoulder 116 to the end 118. The first portion 112 further includes a groove 120 extending circumferentially about the central axis A. The groove 120 may be disposed axially closer to the end 118 than to the shoulder 116.

The bearing 106 includes: an inner ring 122, an outer ring 124 arranged concentrically with the inner ring 122, and rolling bodies 126 disposed between the inner ring 122 and the outer ring 124. The outer ring 124 defines an outer race 128 on a radial inner surface thereof, and the inner ring 122 defines an inner race 130 on a radial outer surface thereof. The inner and outer races 128, 130 define a track 132 therebetween. The track 132 is configured to house the rolling bodies 126. The bearing 106 may include a cage 134 disposed between the outer ring 124 and the inner ring 122. The rolling bodies 126 may be supported by the cage 134.

The rolling bodies 126 may be configured to support radial loads applied to the bearing 106. The rolling bodies 126 may, for example, be ball bearings. Alternatively, the rolling bodies 126 may be any other suitable type of rolling body for supporting radial loads.

The bearing 106 may include a seal 136 disposed at one axial side of the bearing 106. The seal 136 may be configured to seal the bearing 106 at the one axial side from an environment around the bearing 106. That is, the seal 136 may prevent debris from entering the track 132 via the one axial side. The seal 136 may extend from the inner ring 122 to the outer ring 124. The seal 136 may be any suitable type of seal. The bearing 106 may include a further seal 138 disposed at the other axial side of the bearing 106. The further seal 138 may be substantially identical to the seal 136.

The bearing 106 may be disposed axially between the shoulder 116 and the camlock 108, i.e., within the cavity 110. The bearing 106 may contact the shoulder 116. The bearing 106 rotationally supports the shaft 104 in the housing 102. For example, the shaft 104 may be connected, e.g., via a slip-fit connection, to the inner ring 122, and the housing 102 may be connected, e.g., via a press-fit connection, to the outer ring 124. That is, the shaft 104 is designed, i.e., sized and shaped, to be received by the inner ring 122, and the housing 102, i.e., the cavity 110, is designed to receive the outer ring 124. Said differently, the shaft 104 may apply loads to the bearing 106 in a radially outward direction, and the housing 102 may apply loads to the bearing 106 in a radially inward direction.

The camlock 108 includes a body 140 and two arms 142 pivotally connected to the body 140. The body 140 extends annularly about the central axis A and is configured to be arranged on the shaft 104. That is, the body 140 is designed, i.e., sized and shaped, to receive the shaft 104. The body 140 may be connected to the shaft 104, e.g., via a slip-fit connection. The body 140 may contact the inner ring 122. In one embodiment, the body 140 and the inner ring 122 may be a single-piece, integral construction, for example. In another embodiment, the body 140 and the inner ring 122 may be a multi-piece construction and may be fixed together via a welded connection, for example.

The body 140, i.e., an outer radial surface thereof, may be radially aligned with the inner ring 122, i.e., the outer radial surface thereof. That is, an outer radial surface of the body 140 may be disposed radially inside of the seal 136.

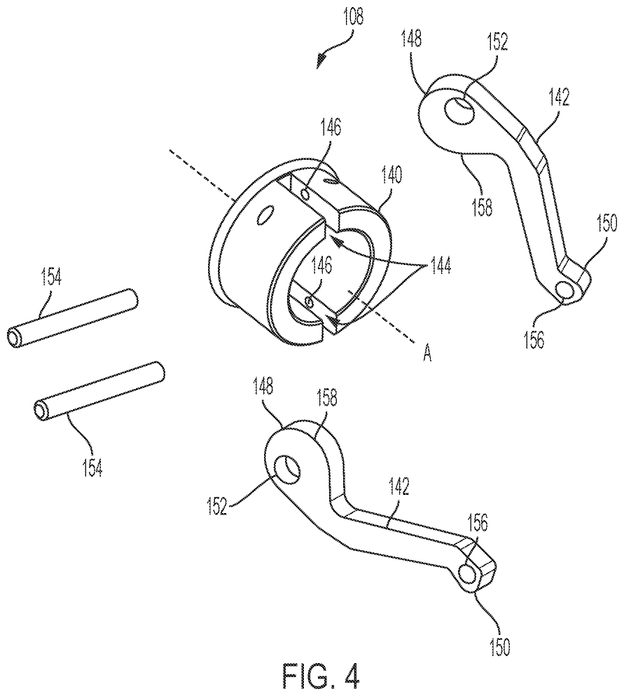

The body 140 may include two slots 144 arranged diametrically opposite of each other relative to the central axis A, as shown in FIG. 4. The slots 144 may extend from one axial side of the body 140 towards another axial side of the body 140. The slots 144 may be axially spaced from the inner ring 122. The body 140 may further include two openings 146 each extending through one respective slot 144 along an axis perpendicular to the central axis A.

Each arm 142 is arranged in one respective slot 144. Each arm 142 includes a first end 148 disposed in the respective slot 144 and a second end 150 disposed external to the respective slot 144. First openings 152 extend through each arm 142 at the respective first ends 148. The first openings 152 are axially and radially aligned with the respective openings 146 such that pins 154 extend through the respective openings 146 and the corresponding first openings 152 to pivotally connect the arms 142 to the body 140. Second openings 156 may extend through each arm 142 at the respective second ends 150.

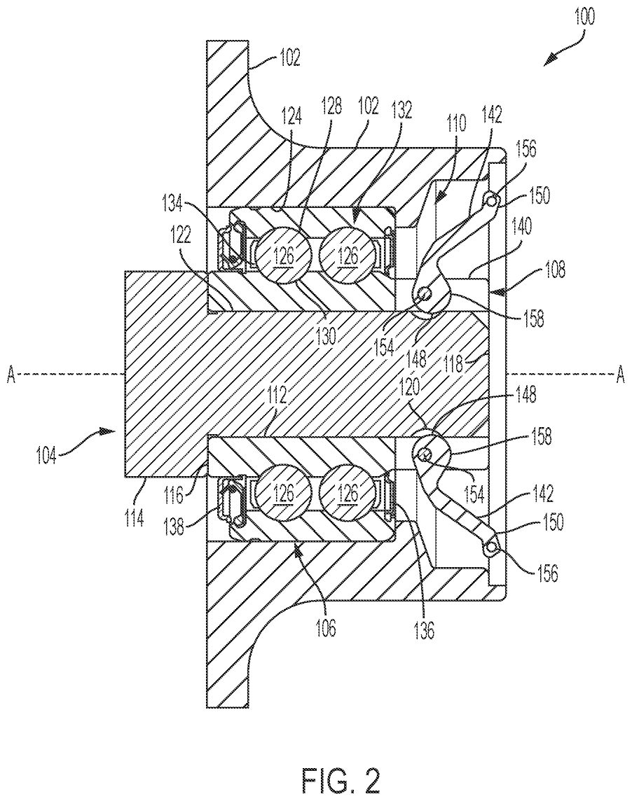

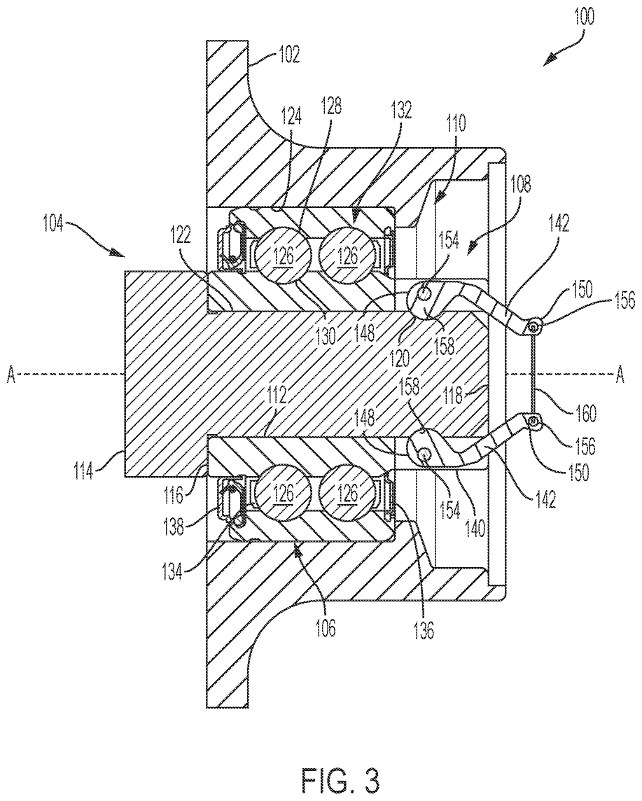

The arms 142 are pivotable between a locked position, as shown in FIG. 3, and an unlocked position, as shown in FIG. 2. Each arm 142 includes a cam 158 at the respective first end 148. The cams 158 are configured to engage the shaft 104 when the arms 142 are in the locked position. In the locked position, the cams 158 are disposed in the groove 120 and contact the groove 120 continuously from one axial side of the groove 120 to another, opposite axial side of the groove 120. Additionally, the cams 158 may be configured to radially compress the shaft 104 when the arms 142 are in the locked position. In the locked position, the cams 158 axially constrain the bearing 106 relative to the shaft 104. That is, the cams 158 prevent relative axial movement between the bearing 106 and the shaft 104 when the arms 142 are in the locked position. Said differently, the cams 158 fix the body 140 relative to the shaft 104 when the arms 142 are in the locked position.

The cams 158 are configured to disengage the shaft 104 when the arms 142 are in the unlocked position. In the unlocked position, the cams 158 are axially spaced from at least one axial side of the groove 120. For example, in the unlocked position, the cams 158 may be disposed, at least partially, external to the groove 120. In the unlocked position, the bearing 106 may move axially relative to the shaft 104. In other words, the cams 158 may permit relative axial movement between the bearing 106 and the shaft 104 when the arms 142 are in the unlocked position. Providing the camlock 108 to selectively engage the shaft 104 allows the camlock 108 and/or bearing 106 to be more quickly removed from the shaft 104, e.g., during maintenance and/or repair, as compared to using a threaded engagement to connect the bearing 106 to the shaft 104.

In the locked position, the second ends 150 of the arms 142 may be radially inside of the corresponding first ends 148. In the unlocked position, the second ends 150 of the arms 142 may be radially outside of the corresponding first ends 148. That is, to move the arms 142 from the unlocked position to the locked position, the second ends 150 may be pressed, e.g., by a human operator, towards the central axis A, and to move the arms 142 from the locked position to the unlocked position, the second ends 150 may be pushed, e.g., by a human operator, away from the central axis A.

The second ends 150 of the arms 142 may be selectively connectable to each other. For example, the camlock 108 may include a wire 160 selectively engageable with at least one of the second openings 156. For example, when the arms 142 are in the locked position, the wire 160 may be engaged with the second ends 150. In such an example, the wire 160 may be inserted through the second opening(s) 156, e.g., via a human operator. As an example, the wire 160 may be inserted into each second opening 156. As another example, the wire 160 may be fixed to the second end 150 of one arm 142, e.g., via the respective second opening 156. In this situation, the wire 160 may be inserted into the second opening 156 of the other arm 142 when the arms 142 are in the locked position. The wire 160 may be configured to retain the arms 142 in the locked position, e.g., by applying a radially inward force on the second ends 150 of each arm 142. The wire 160 is removable, e.g., by the human operator, from the second opening(s) 156 to permit the arms 142 to move from the locked position to the unlocked position.

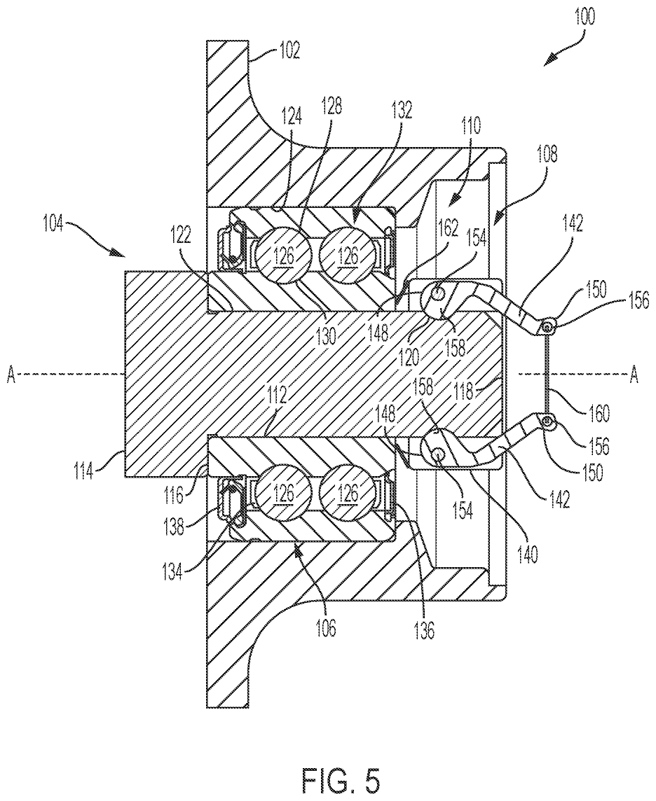

Referring to FIG. 5, an alternative embodiment for a bearing camlock is provided. In contrast to FIGS. 1-3, the body 140 is axially spaced from the inner ring 122. That is, the camlock 108 and the bearing 106 are separate components. In this embodiment, the assembly 100 includes a spring 162 disposed axially between the camlock 108 and the bearing 106. Specifically, the spring 162 is engaged with the body 140 and the inner ring 122. The spring 162 is configured to bias the bearing 106 towards the shoulder 116. That is, the spring 162 biases the bearing 106 and the camlock 108 axially away from each other. The spring 162 may be any suitable type of compression spring.

Providing the camlock 108 as a separate component from the bearing 106 can reduce cost and complexity of the bearing 106. Additionally, the outer radial surface of the body 140 may be radially offset relative to the outer radial surface of the inner ring 122. For example, the outer radial surface of the body 140 may be disposed radially outside of the outer radial surface of the inner ring 122. In this situation, the body 140 may axially overlap the seal 136, which may assist in sealing the bearing 106.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 assembly
102 housing
104 shaft
106 bearing
108 camlock
110 cavity
112 first portion
114 second portion
116 shoulder
118 end
120 groove
122 inner ring
124 outer ring
126 rolling bodies
128 outer race
130 inner race
132 track
134 cage
136 seal
138 seal
140 body
142 arm
144 slot
146 opening
148 end
150 end
152 opening
154 pin
156 opening
158 cam
160 wire
162 spring
A central axis

What is claimed is:

1. An assembly, comprising:
a housing;
a shaft arranged concentrically with the housing, the shaft being rotatable relative to the housing;
a bearing supporting the shaft in the housing; and
a camlock configured to axially constrain the bearing relative to the shaft, the camlock including:
a body arranged on the shaft; and
two arms pivotally connected to the body, the arms being selectively engageable with the shaft to fix the body relative to the shaft.

2. The assembly of claim 1, wherein the shaft includes a shoulder disposed external to the housing, the bearing being disposed between the shoulder and the camlock.

3. The assembly of claim 2, wherein the camlock is axially spaced from the bearing and a spring is disposed between the camlock and the bearing, the spring being configured to engage the camlock and the bearing and to axially bias the bearing towards the shoulder.

4. The assembly of claim 1, wherein the bearing includes an inner ring and an outer ring arranged concentrically with the inner ring, the body of the camlock being integral with the inner ring.

5. The assembly of claim 1, wherein the bearing includes an inner ring and an outer ring arranged concentrically with the inner ring, the body of the camlock being radially aligned with the inner ring.

6. The assembly of claim 1, wherein the body is spaced from the bearing and a spring is disposed between the body and the bearing, the spring being configured to engage the body and the bearing and to axially bias the bearing away from the camlock.

7. The assembly of claim 1, wherein the shaft includes a groove extending circumferentially about the shaft, each arm including a cam configured to engage the shaft in the groove.

8. The assembly of claim 1, wherein the body includes two slots arranged diametrically opposite of each other, each arm being disposed in one respective slot.

9. The assembly of claim 1, wherein each arm includes a first end having a cam configured to engage the shaft and a second end spaced from the first end, the second ends of the arms being selectively connectable to each other.

10. The assembly of claim 9, wherein, in a locked position, the second ends are connected to each other.

11. The assembly of claim 10, wherein the camlock includes a wire selectively engageable with the second ends of the arms when the camlock is in the locked position.

12. The assembly of claim 1, wherein each arm includes a cam configured to engage the shaft.

13. A camlock, comprising:
a body configured to be arranged on a shaft; and
two arms pivotally connected to the body, the arms being configured to selectively engage the shaft to fix the body relative to the shaft.

14. The camlock of claim 13, wherein each arm includes a cam configured to engage the shaft.

15. The camlock of claim 13, wherein the body includes two slots arranged diametrically opposite of each other, each arm being disposed in one respective slot.

16. The camlock of claim 13, wherein each arm includes a first end having a cam configured to engage the shaft and a second end spaced from the first end, the second ends of the arms being selectively connectable to each other.

17. The camlock of claim 16, wherein, in a locked position, the second ends are connected to each other.

18. The camlock of claim 17, further comprising a wire selectively engageable with the second ends of the arms when the camlock is in the locked position.

19. An assembly, comprising:
a bearing; and
a camlock configured to axially constrain the bearing relative to a shaft, the camlock including:
a body configured to be arranged on the shaft; and
two arms pivotally connected to the body, the arms being configured to selectively engage the shaft to fix the body relative to the shaft.

20. The camlock of claim 19, wherein the bearing includes an inner ring and an outer ring arranged concentrically with the inner ring, the body of the camlock being integral with the inner ring.
